(19) United States
(12) Patent Application Publication
(10) Pub. No.: US 2021/0317292 A1
(43) Pub. Date: Oct. 14, 2021

(54) THERMOPLASTIC RESIN COMPOSITION AND MANUFACTURING METHOD THEREFOR

(71) Applicant: Konica Minolta, Inc., Tokyo (JP)

(72) Inventors: Yo NAKAJIMA, Tokyo (JP); Yuuki NAGAI, Tokyo (JP); Masashi MAMINO, Tokyo (JP); Takeshi KOJIMA, Tokyo (JP)

(21) Appl. No.: 17/201,473

(22) Filed: Mar. 15, 2021

(30) Foreign Application Priority Data
Apr. 8, 2020 (JP) 2020-069470

(51) Int. Cl. C08L 23/12; C08L 23/06

(52) U.S. Cl. CPC C08L 23/12; C08L 2207/04; C08L 23/06

(57) ABSTRACT

Provided is a thermoplastic resin composition containing a thermoplastic resin A, a hard filler B and a compatibilizer C, wherein the hard filler B contains a hard filler B1 having an average particle diameter in the range of 0.7 to 40 μm and a hard filler B2 having an average particle diameter in the range of 0.01 to 0.5 μm, the compatibilizer C at least adheres to a surface of the hard filler B1, and a ratio W_{B1}/W_{B2} is 1.5 or more, when W_{B1} and W_{B2} are adhesion masses of the compatibilizer C adhered to the surfaces of the hard filler B1 and the hard filler B2, respectively, and W_{B1} and W_{B2} each are measured per unit cross-sectional area.

### CROSS-REFERENCE TO RELATED APPLICATION

The entire disclosure of Japanese Patent Application No. 2020-069470 filed on Apr. 8, 2020 is incorporated herein by reference in its entirety.

### BACKGROUND

### Technological Field

The present invention relates to a thermoplastic resin composition and a method for producing the same. More particularly, the present invention relates to a thermoplastic resin composition capable of achieving both rigidity and toughness (impact resistance) at a high level in a molded article obtained using the same thermoplastic resin composition, and a method for producing the same.

### Description of the Related Art

As a resin composition used for molding interior and exterior materials of office equipment, a resin composition capable of achieving both high rigidity and toughness of the obtained resin member is required. In particular, in the miniaturization and weight reduction of the office equipment, when thinning of the resin member is required, rigidity and toughness are needed even if the thickness is reduced, and it is necessary to maintain the same level as the member before thinning. That is, the resin composition is required to have a configuration in which the obtained resin member can achieve both rigidity and toughness at a higher level.

In response to such a request, Patent Document 1 (JP-A 5-311032) discloses a resin composition in which an inorganic filler surface-modified with respect to a polypropylene-based resin and an elastomer having a specific structure are blended, and it is described that a balance between rigidity and toughness of a molded article obtained by this is retained. However, in the resin composition described in Patent Document 1, the obtained molded product has a large decrease in toughness due to filler and a large decrease in rigidity due to elastomer, and it is difficult to say that rigidity and toughness are compatible at a high level.

### SUMMARY

In view of the above problems and status, an object of the present invention is to provide a thermoplastic resin composition in which a molded article obtained using the thermoplastic resin composition can achieve both rigidity and toughness at a high level, and a method for producing the same.

In order to solve the above-mentioned problems, the present inventor has found the following in the process of examining the causes of the above-mentioned problems. In other words, it has been found that, in a thermoplastic resin composition containing a thermoplastic resin, a compatibilizer is contained with a hard filler having a different average particle diameter, and an adhesion mass of the compatibilizer adhering to the surface of the hard filler having a large average particle diameter, which is measured in a cross section having a predetermined area, is made larger than an adhesion mass of the compatibilizer adhering to the surface of the hard filler having a small average particle diameter by a predetermined ratio or more, whereby the molded article obtained from the thermoplastic resin composition can achieve both rigidity and toughness at a high level, thereby leading to the present invention. In other words, the above problem according to the present invention is solved by the following means.

To achieve at least one of the abovementioned objects, a thermoplastic resin composition that reflects an aspect of the present invention is as follows.

A thermoplastic resin composition containing a thermoplastic resin A, a hard filler B and a compatibilizer C, wherein the hard filler B contains a hard filler B1 having an average particle diameter in the range of 0.7 to 40 μm and a hard filler B2 having an average particle diameter in the range of 0.01 to 0.5 μm, the compatibilizer C at least adheres to a surface of the hard filler B1, and a ratio W_{B1}/W_{B2} is 1.5 or more, when W_{B1} and W_{B2} are adhesion masses of the compatibilizer C adhered to the surfaces of the hard filler B1 and the hard filler B2, respectively, provided that W_{B1} and W_{B2} each are measured per unit cross-sectional area.

By the above means of the present invention, it is possible to provide a thermoplastic resin composition in which a molded article obtained using the thermoplastic resin composition can achieve both rigidity and toughness at a high level, and it is possible to provide a method for producing the same.

The expression mechanism or action mechanism of the effect of the present invention is not clarified, but is inferred as follows.

A molded article obtained from a thermoplastic resin composition containing a thermoplastic resin and a hard filler has a configuration in which a hard filler is dispersed in a matrix made of a thermoplastic resin. As for the rigidity of the molded article, the presence of a harder filler having a higher hardness in the matrix itself improves.

On the other hand, the toughness (impact strength) of the molded article depends on the balance between the amount of interface between the matrix and the hard filler and its strength. Specifically, when the molded article is subjected to an impact, stress concentration occurs at the interface between the matrix and the hard filler. When the stress reaches a sufficient amount, interface fracture occurs, the hard filler peels off from the matrix, and the stress is relaxed, so that the molded article has a toughness to withstand the impact. Furthermore, at that time, voids are generated and the toughness is improved by stress relaxation due to the voids. However, when stress is concentrated, if the interface strength is weak, cracks occur in the matrix starting from the interface, and the toughness decreases.

In the improvement of the toughness, when the particle diameter of the hard filler is small, the amount of interface with the matrix is large, which is advantageous, but since the stress concentration is small and it is difficult to peel off from the matrix, the toughness effect is hardly exhibited by dispersing the hard filler alone in the matrix. On the other hand, when the particle diameter of the hard filler is large, it is possible to increase the stress concentration, but cracks are likely to occur in the matrix starting from the interface, it becomes a factor of lowering the toughness by hindering stress relaxation.

In view of the above, in the thermoplastic resin composition of the present invention, a thermoplastic resin, a hard filler having a small diameter, a hard filler having a large diameter and a compatibilizer are contained, and the adhesion mass of the compatibilizer adhering to the surface of the hard filler having a large diameter is made larger than the adhesion mass of the compatibilizer adhering to the surface of the hard filler having a small diameter by a predetermined ratio or more. The adhesion masses are respectively measured in a cross section having a predetermined area, so that the amount of the interface and the strength are balanced.

The molded article obtained from the thermoplastic resin composition of the present invention achieves a high level of toughness by causing a large stress concentration by the large diameter hard filler at the time of impact and increasing the peeling probability of the small diameter hard filler from the force as a starting point. Further, it is considered that the surface of the hard filler having a large diameter is interface-strengthened by the compatibilizer, and therefore, the occurrence of cracks in the matrix from the interface of the hard filler having a large diameter is suppressed. When a compatibilizer is similarly applied to a small-diameter hard filler, the probability of peeling is reduced and the toughness is lowered. Therefore, the toughness is lowered by specifying the amount of the compatibilizer attached as described above. Further, it is assumed that a synergistic effect is obtained in which stress concentration at the interface of a hard filler having a large diameter can be suppressed by alleviating voids caused by a hard filler having a small diameter in the periphery.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram schematically showing a cross section of a thermoplastic resin composition according to the present invention.

FIG. 2A is a diagram showing a unit cross-sectional area region for measuring the adhesion mass of the compatibilizer C on the surface of the hard filler B1.

FIG. 2B is a diagram showing a unit cross-sectional area region for measuring the adhesion mass of the compatibilizer C on the surface of the hard filler B2.

### DETAILED DESCRIPTION OF THE EMBODIMENTS

Hereinafter, one or more embodiments of the present invention will be described. However, the scope of the invention is not limited to the disclosed embodiments.

The thermoplastic resin composition of the present invention is a thermoplastic resin composition containing a thermoplastic resin A, and a hard filler B and a compatibilizer C, wherein the hard filler B contains a hard filler B1 having an average particle diameter in the range of 0.7 to 40 μm and a hard filler B2 having an average particle diameter in the range of 0.01 to 0.5 μm, the compatibilizer C at least adheres to a surface of the hard filler B1, and a ratio W_{B1}/W_{B2} is 1.5 or more, when W_{B1} and W_{B2} are adhesion masses of the compatibilizer C adhered to the surfaces of the hard filler B1 and the hard filler B2, respectively, and W_{B1} and W_{B2} each are measured per unit cross-sectional area. This feature is a technical feature common to the following embodiments.

In an embodiment of the thermoplastic resin composition of the present invention, from the viewpoint of the effect of the present invention, it is preferable that the ratio W_{B1}/W_{B2} of the adhesion masses is 3 or more.

As an embodiment of the thermoplastic resin composition of the present invention, from the viewpoint of expressing the effect of the present invention, it is preferable that a ratio B1/B2 of the mass of the hard filler B1 to the mass of the hard filler B2 is in the range of 2.0 to 5.0.

As an embodiment of the thermoplastic resin composition of the present invention, from the viewpoint of expressing the effect of the present invention, it is preferable that the thermoplastic resin A, the hard filler B1, the hard filler B2, and the compatibilizer C respectively have a content based on the total mass of the thermoplastic resin composition, 65 to 90% by mass for the thermoplastic resin A, 5 to 20% by mass for the hard filler B1, 1 to 10% by mass for the hard filler B2, and 0.5 to 5% by mass for the compatibilizer C.

As an embodiment of the thermoplastic resin composition of the present invention, from the viewpoint of expressing the effect of the present invention, it is preferable that the average particle diameter of the hard filler B1 is in the range of 0.8 to 5 μm and the average particle diameter of the hard filler B2 is in the range of 0.03 to 0.2 μm.

As an embodiment of the thermoplastic resin composition of the present invention, when the thermoplastic resin A is a polypropylene-based resin, the effect of the present invention is more remarkably expressed and preferred.

As an embodiment of the thermoplastic resin composition of the present invention, from the viewpoint of expressing the effect of the present invention, it is preferable that the constituent material of the hard filler B1 is any of magnesium hydroxide, aluminum hydroxide, boehmite, talc, or mica.

As an embodiment of the thermoplastic resin composition of the present invention, from the viewpoint of expressing the effect of the present invention, it is preferable that the constituent material of the hard filler B2 is any of calcium carbonate, silica, kaolin, aluminum hydroxide, or boehmite.

As an embodiment of the thermoplastic resin composition of the present invention, from the viewpoint of expressing the effect of the present invention, it is preferable that the compatibilizer C is a maleic anhydride modified product of the thermoplastic resin A.

A method for producing a thermoplastic resin composition of the present invention is a method for producing a thermoplastic resin composition of the present invention, comprising a first step of melt-kneading the thermoplastic resin A, the hard filler B1, and the compatibilizer C to obtain a resin mixture, and a second step of melt-kneading the above-described resin mixture and the hard filler B2.

By performing the above-described two times of melt-kneading steps, it is possible to easily achieve a configuration in which the compatibilizer C at least adheres to a surface of the hard filler B1 and the adhesion mass W_{B1} of the compatibilizer C adhering to the surface of the hard filler B1 is 1.5 times or more of the adhesion mass W_{B2} of the compatibilizer C adhering to a surface of the hard filler B2, provided that the adhesion masses W_{B1} and W_{B2} each are measured in a cross section of a predetermined area, respectively. Thus, the molded article obtained from the thermoplastic resin composition can achieve both rigidity and toughness at a high level.

Hereinafter, the present invention and the constitution elements thereof, as well as configurations and embodiments to carry out the present invention, will be detailed in the following. In the present description, when two figures are used to indicate a range of value before and after “to”, these figures are included in the range as a lowest limit value and an upper limit value.

### [Summary of Thermoplastic Resin Composition]

The thermoplastic resin composition of the present invention is a thermoplastic resin composition containing a thermoplastic resin A, a hard filler B and a compatibilizer C, wherein the hard filler B contains a hard filler B1 having an average particle diameter in the range of 0.7 to 40 μm and a hard filler B2 having an average particle diameter in the range of 0.01 to 0.5 μm, the compatibilizer C at least adheres to a surface of the hard filler B1, and a ratio W_{B1}/W_{B2} is 1.5 or more, when W_{B1} and W_{B2} are adhesion masses of the compatibilizer C adhered to the surfaces of the hard filler B1 and the hard filler B2, respectively, provided that W_{B1} and W_{B2} each are measured per unit cross-sectional area. This is one of the features of the present invention.

In the present invention, the term “hard” in the hard filler B means a property harder than that of the thermoplastic resin A. Specifically, when the flexural modulus by a flexural test performed in accordance with JIS-K7171 is larger than the flexural modulus by a test piece made of the thermoplastic resin A alone, then, the filler is defined as the hard filler B.

The average particle diameters of the hard filler B1 and the hard filler B2 each are the average dispersion particle diameter of the respective hard filler in the thermoplastic resin composition measured by the following method. The average dispersion particle diameter is measured by preparing a specimen obtained by molding a thermoplastic resin composition into, for example, a pellet, taking an electron micrograph of a cross section thereof, and analyzing the obtained image.

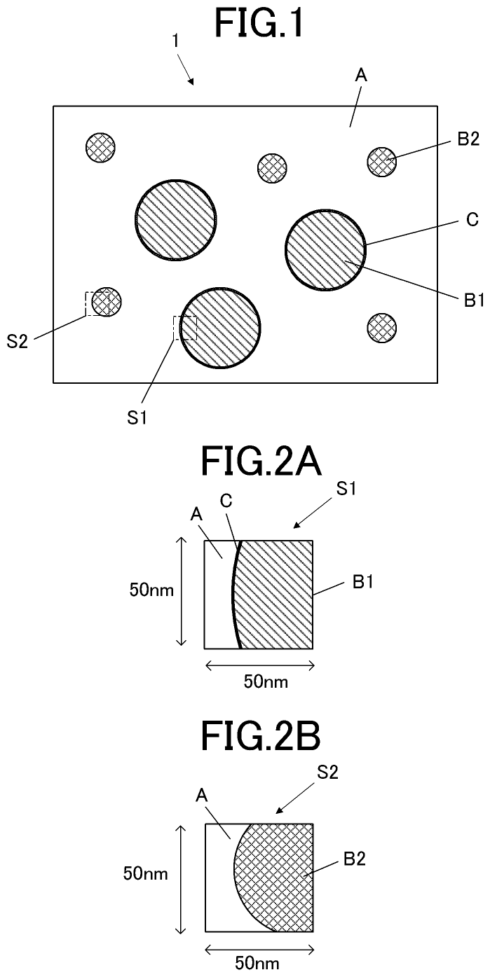

FIG. 1 is a diagram schematically showing a cross section of a thermoplastic resin composition according to the present invention. In a cross section 1 of an analyte of a thermoplastic resin composition, a hard filler B1 and a hard filler B2 are dispersed in a matrix of a thermoplastic resin A. Although the compatibilizer C is shown in FIG. 1 as adhering only to the surface of the hard filler B1, the compatibilizer C may adhere to the surface of the hard filler B2 as long as W_{B1}/W_{B2} is within the above ranges. Also, in FIG. 1, the deposited layer of compatibilizer C is shown with a predetermined thickness, but the actual thickness of the deposited layer is not as thick as can be observed at the magnification of the image for measuring the particle diameter of hard filler B1 and hard filler B2, and therefore it does not affect the particle diameter measurement.

Further, the compatibilizer C may be adhered to the entire surface of the hard filler B1 and may be partially adhered. When the compatibilizer C is adhered to the surface of the hard filler B2, it may be adhered to the entire surface as well, and may be partially adhered. When adhering to the entire surface, the thickness to which the compatibilizer C adheres may be uniform and may vary.

In an image for measuring the dispersion particle diameter of the hard filler B1 and the hard filler B2, when the difference in the dispersion particle diameter of both is sufficiently large, it is possible to discriminate the hard filler B1 and the hard filler B2 as in the cross section shown in FIG. 1. When the difference between the dispersion particle diameters of the hard filler B1 and the hard filler B2 is small, an image in which the total number of the dispersion particles exceeds 200 and approximates 200 is selected, and the dispersion particle diameters of all the dispersion particles present in the image are measured by the following method. The image in which the number of the dispersed particles is present may be composed of one image according to the size of the dispersed particle diameter of the dispersed particles, or a plurality of images may be combined to form an image in which the number of the dispersed particles is present. The dispersion particle diameters are arranged in order from the smallest to the middle of the dispersion particle diameter as a reference, and those larger than the reference dispersion particle diameter are referred to as a hard filler B1, and those smaller than the reference dispersion particle diameter are referred to as a hard filler B2.

Here, the dispersion particle diameter refers to a particle diameter of a hard filler B observed as particles of a continuous phase in a cross-sectional image of a thermoplastic resin composition. Specifically, the hard filler B is dispersed in the state of primary particles or secondary particles in which the primary particles are aggregated. When the hard filler B is dispersed in the state of the primary particles, the particle diameter of the primary particles is a dispersed particle diameter, and when dispersed in the state of the secondary particles, the particle diameter of the secondary particles is a dispersed particle diameter. In the present invention, the dispersed particle diameter is a circle equivalent diameter which is a diameter of a perfect circle corresponding to the area of the dispersed particle. The average dispersion particle diameter is obtained by measuring and averaging a circle equivalent diameter for 100 dispersed particles of each of the randomly extracted hard filler B1 and the hard filler B2 in the above image.

The adhesion mass W_{B1} of the compatibilizer C attached to the surface of the hard filler B1 measured per unit cross-sectional area and the adhesion mass W_{B2} of the compatibilizer C attached to the surface of the hard filler B2 measured per unit cross-sectional area may be obtained by, for example, nano-IR spectroscopy (nano-infrared spectroscopy). Nano-IR is measured at a unit cross-sectional area of the flaky analyte, e.g., having a size of 50 nm×50 nm.

Specifically, a thermoplastic resin composition in the form of a pellet (analyte) is made into a flake of about several hundred nanometers in a microtome, and the flake is observed by atomic force microscopy (AFM), and nano-IR is measured for the hard filler B1 and the hard filler B2 by determining the measurement area, respectively.

The measured area of nano-IR is made to be 50 nm×50 nm. The measurement region for the hard filler B1 is selected so that the ratio occupied by the cross-sectional area of the hard filler B1 in the measurement region (50 nm×50 nm) is in the range of 60 to 80%. FIG. 2A is a view enlarging and illustrating the region S1 of the unit cross-sectional area (50 nm×50 nm) for measuring the adhesion mass of the compatibilizer C on the surface of the hard filler B1 randomly selected from the cross section 1 of the thermoplastic resin composition shown in FIG. 1. In the region S1, the ratio occupied by the cross-sectional area of rigid filler B1 is about 70%, which is in the range of 60 to 80% defined above. A measurement area similar to the region S1 is selected at four more random locations to prepare a measurement area for a total of five hard fillers B1. Although there is a case where the hard filler B1 is cut at the time of flaking, it can be specified by observing a long side.

Similarly, the measurement region for the hard filler B2 is selected so that the ratio occupied by the cross-sectional area of the hard filler B2 in the measurement region (50 nm×50 nm) is in the range of 60 to 80%. FIG. 2B is an enlarged view showing the region S2 of the unit cross-sectional area (50 nm×50 nm) for measuring the adhesion mass of the compatibilizer C on the surface of the hard filler B2 randomly selected from the cross section 1 of the thermoplastic resin composition shown in FIG. 1. In the region S2, the ratio of the cross-sectional area of rigid filler B2 is about 65%, which is in the range of 60 to 80% defined above. A measurement area similar to the region S2 is selected at four more random locations to prepare a measurement area for a total of five hard filler B2.

Nano-IR is measured for each of the five measurement regions selected for the hard filler B1 and the hard filler B2, and the peak intensity of the specific absorption wavelength of the compatibilizer C is measured. For example, when the hard filler B1 and the hard filler B2 are inorganic compounds and the thermoplastic resin A is a polypropylene-based resin and the compatibilizer C is a maleic anhydride modified product of a polypropylene-based resin, the peak intensity of the carbonyl group (C═O) in the range of 1830 to 1890 cm⁻¹ is measured.

The value obtained by dividing the average value P_{B1} of the peak intensity measured at five points of the measurement area for the hard filler B1 by the average value P_{B2} of the peak intensity measured at five points of the measurement area for the hard filler B2 corresponds to a ratio W_{B1}/W_{B2}.

The thermoplastic resin composition of the present invention has the above-mentioned W_{B1}/W_{B2} of 1.5 or more, whereby the above-mentioned effects of the present invention can be obtained. W_{B1}/W_{B2} is preferably 3 or more, and particularly preferably 10 or more.

### [Composition of Thermoplastic Resin Composition]

The thermoplastic resin composition of the present invention is a thermoplastic resin composition containing a thermoplastic resin A, a hard filler B and a compatibilizer C, wherein the hard filler B contains a hard filler B1 having an average particle diameter in the range of 0.7 to 40 μm and a hard filler B2 having an average particle diameter in the range of 0.01 to 0.5 μm, and the compatibilizer C at least adheres to a surface of the hard filler B1, and the above W_{B1}/W_{B2} is 1.5 or more.

### (Thermoplastic Resin A)

In the present invention, as the thermoplastic resin A, a known thermoplastic resin is used without any particular limitation. Examples of the thermoplastic resin include polyester resins such as polyolefin-based resins, polystyrene resins, acrylonitrile-butadiene-styrene copolymers (ABS resins), polycarbonate resins, and polyethylene terephthalate. These may be used alone, or in combination of two or more.

It is preferable that the thermoplastic resin A contains a polyolefin-based resin as a main component. The content of the polyolefin-based resin in the thermoplastic resin A is preferably 50% by mass or more, more preferably 60% by mass or more, and still more preferably 80% by mass or more, based on the total amount of the thermoplastic resin A. In the thermoplastic resin composition of the present invention, it is particularly preferable that the thermoplastic resin A is made of only a polyolefin-based resin.

The content of the thermoplastic resin A in the thermoplastic resin composition of the present invention is an amount obtained by excluding the content of the hard filler B and the compatibilizer C and optionally containing various other additives from the thermoplastic resin composition.

In the thermoplastic resin composition of the present invention, the content of the thermoplastic resin A may be about 60 to 90% by mass, preferably 65 to 90% by mass, and more preferably 75 to 85% by mass, based on the total mass of the thermoplastic resin A, the hard filler B1, the hard filler B2, and the compatibilizer C from the viewpoint of balance of rigidity and toughness.

### <Polyolefin-Based Resin>

The polyolefin-based resin is a homopolymer or a copolymer obtained by polymerizing an olefin as a main component of a monomer component. In this specification, “olefin” refers to an unsaturated aliphatic chain hydrocarbon having one double bond.

Here, the main component constituting the resin (polymer) refers to a component which is 50% by mass or more in all monomer components constituting the polymer. The polyolefin-based resin is a homopolymer or a copolymer containing an olefin in an amount of preferably 60 to 100% by mass, more preferably 70 to 100% by mass, and still more preferably 80 to 100% by mass, in the total monomer components.

The olefin copolymer includes a copolymer of an olefin and another olefin, or a copolymer of an olefin and another monomer copolymerizable with an olefin. The content of the above other monomers in the polyolefin-based resin is preferably 30% by mass or less, more preferably 0 to 20% by mass, in the total monomer components.

As the olefin, an α-olefin having 2 to 12 carbon atoms is preferred. Examples of the olefin include ethylene, propylene, 1-butene, isobutene, 1-pentene, 3-methyl-1-butene, 1-hexene, 1-octene, and 1-decene. In the polymerization of the polyolefin-based resin, one kind of olefin may be used alone, or 2 or more kinds thereof may be used in combination.

Other monomers copolymerizable with olefins may include, for example, cyclic olefins such as cyclopentene and norbornene, and dienes such as 1,4-hexadiene and 5-ethylidene-2-norbornene. Further, monomers such as vinyl acetate, styrene, (meth)acrylic acid and derivatives thereof, vinyl ether, maleic anhydride, carbon monoxide, and n-vinylcarbazole may be used. In the other monomers described above, one kind may be used alone in the polymerization of the polyolefin-based resin, or 2 or more kinds thereof may be used in combination. Note that, “(meth)acrylic acid” means at least one of acrylic acid and methacrylic acid.

Specific examples of the polyolefin-based resin include polyethylene resins mainly containing ethylene such as high-density polyethylene (HDPE), low-density polyethylene (LDPE), and linear low-density polyethylene (LLDPE); polypropylene-based resins mainly containing propylene such as polypropylene (propylene homopolymer), ethylene-propylene copolymer, propylene-butene copolymer, ethylene-propylene-butene copolymer, and ethylene-propylene-diene copolymer; polybutene; and polypentene.

Specific examples of the polyolefin-based resin further include an ethylene-vinyl acetate copolymer (EVA), an ethylen-ethylacrylate copolymer, a polyketone, and a copolymer produced by a metallocene catalyst. Also included are those obtained by chemically reacting and modifying these polymers, specifically ionomer resins, saponified products of EVA, and olefinic elastomers produced using dynamic vulcanization in an extruder.

As the polyolefin-based resin, a polyethylene-based resin and a polypropylene-based resin are preferred, and a polypropylene-based resin is more preferred. The stereoregularity of the structure derived from propylene in the polypropylene-based resin may be any of isotactic, syndiotactic, or atactic. As the polypropylene-based resin, polypropylene is further preferred.

### (Hard Filler B)

In the present invention, the hard filler B contains a hard filler B1 having an average particle diameter in the range of 0.7 to 40 μm and a hard filler B2 having an average particle diameter in the range of 0.01 to 0.5 μm. In addition to the hard filler B1 and the hard filler B2, the hard filler B may contain, for example, a hard filler having an average particle diameter larger than that of the hard filler B1 and a hard filler having a smaller average particle diameter than that of the hard filler B2. From the viewpoint of expressing the effect of the present invention, it is preferable that the hard filler B does not contain a hard filler other than the hard filler B1 and the hard filler B2.

### <Hard Filler B1>

The hard filler B1 has an average particle diameter in the range of 0.7 to 40 μm, more preferably in the range of 0.8 to 5 μm, and still more preferably in the range of 0.8 to 1.2 μm. The average particle diameter as described above is an average dispersion particle diameter in a state in which the hard filler B1 is dispersed in the matrix of the thermoplastic resin A.

The material constituting the hard filler B1 may be any of an inorganic material, an organic material, or an inorganic organic composite material, for example, as long as the material constituting the hard filler B1 may fall within the definition of the hard filler B described above by constituting the material. The constituent material of the hard filler B1 is preferably an inorganic filler having a higher hardness. Specifically, it is preferable that the constituent material of the hard filler B1 is any of magnesium hydroxide, aluminum hydroxide, boehmite, talc, or mica. The hard filler B1 may be composed of a single kind of constituent material and may be composed of 2 or more kinds of different constituent materials.

In the thermoplastic resin composition of the present invention, the dispersion particle diameter of the hard filler B1 is controllable by the primary particle diameter of the raw material particles used in preparing the thermoplastic resin composition. The primary particle diameter of the raw material particles of the hard filler B1 measured by the laser diffraction and scattering method is preferably 0.7 to 40 μm, more preferably 0.8 to 5.0 μm, and still more preferably 0.8 to 1.2 μm as the median diameter (D50) on a volume basis. The particle shape of the raw material particles of the hard filler B1 is not particularly limited, and examples thereof include spherical, spindle-like, plate-like, scaly, needle-like, and fibrous.

The raw material particles of the hard filler B1 may be surface-modified by a surface modifier if necessary. As the surface modifier used for the surface modification, an alkylsilazane-based compound such as hexamethyldisilazane (HMDS), an alkylalkoxysilane-based compound such as dimethyldimethoxysilane, dimethyldiethoxysilane, trimethylmethoxysilane, methyltrimethoxysilane, or butyltrimethoxysilane, a chlorosilane-based compound such as dimethyldichlorosilane or trimethylchlorosilane, a silicone oil, a silicone varnish, and various fatty acids, may be used. One kind of the surface modifying agent may be used alone, or 2 or more kinds thereof may be mixed and used.

### <Hard Filler B2>

The hard filler B2 has an average particle diameter in the range of 0.01 to 0.5 μm, more preferably in the range of 0.03 to 0.2 μm, and still more preferably in the range of 0.05 to 0.08 μm. The average particle diameter as described above is an average dispersion particle diameter in a state in which the hard filler B2 is dispersed in the matrix of the thermoplastic resin A.

The material constituting the hard filler B2 may be any of an inorganic material, an organic material, or an inorganic organic composite material, for example, as long as the material constituting the hard filler B2 may fall within the definition of the hard filler B described above by constituting the material. The constituent material of the hard filler B2 is preferably an inorganic filler having a higher hardness. Specifically, it is preferable that the constituent material of the hard filler B2 is any of calcium carbonate, silica, kaolin, aluminum hydroxide, or boehmite. The constituent materials of the hard filler B1 may be one kind or 2 or more kinds.

In the thermoplastic resin composition of the present invention, the dispersion particle diameter of the hard filler B2 is controllable by the primary particle diameter of the raw material particles used in preparing the thermoplastic resin composition. The primary particle diameter of the raw material particles of the hard filler B2 measured by the laser diffraction/scattering method is preferably 0.01 to 0.5 μm, more preferably 0.03 to 0.2 μm, and still more preferably 0.05 to 0.08 μm as the median diameter (D50) on a volume basis. The particle shape of the raw material particles of the hard filler B2 is not particularly limited, and examples thereof include spherical, spindle-like, plate-like, scaly, needle-like, and fibrous.

The raw material particles of the hard filler B2 may be surface-modified by a surface modifier if necessary. As the surface modifier used for surface modification, those exemplified as the surface modifier used for the hard filler B1 may be used as it is. One kind of the surface modifying agent may be used alone, or 2 or more kinds thereof may be mixed and used.

In the thermoplastic resin composition of the present invention, the relationship between the average particle diameters of the hard filler B1 and the hard filler B2 may be as follows. The average particle diameters of the hard filler B1 may be about 2 to 25 times of the average particle diameter of the hard filler B2, preferably in the range of 5 to 25 times, and more preferably in the range of 10 to 25 times.

In the thermoplastic resin composition of the present invention, the ratio B1/B2 of the content (mass) of the hard filler B1 to the content (mass) of the hard filler B2 may be about 1.0 to 9.0, and is preferably in the range of 2.0 to 5.0, and more preferably in the range of 2.5 to 3.5. When B1/B2 is within the above range, it is easy to achieve both rigidity and toughness of the molded article obtained using the thermoplastic resin composition of the present invention.

Further, in the thermoplastic resin composition of the present invention, the content of the hard filler B1 may be set to about 5 to 25% by mass, preferably in the range of 5 to 20% by mass, and more preferably in the range of 8 to 15% by mass, based on the total mass of the thermoplastic resin A, the hard filler B1, the hard filler B2, and the compatibilizer C. In the thermoplastic resin composition of the present invention, the content of the hard filler B2 may be set to about 1 to 15% by mass, preferably in the range of 1 to 10% by mass, and more preferably in the range of 2 to 5% by mass, based on the total mass of the thermoplastic resin A, the hard filler B1, the hard filler B2, and the compatibilizer C.

### (Compatibilizer C)

In the thermoplastic resin composition of the present invention, the compatibilizer C is used for adjusting the interfacial strength of the thermoplastic resin A and the hard filler B. It is preferable that the compatibilizer C is a component capable of improving the interfacial strength by increasing the affinity between the thermoplastic resin A and the hard filler B1 in particular.

As the compatibilizer C, specifically, those having the same structure or compatible structure as the thermoplastic resin A and containing a site having an affinity for the hard filler B1 in a part of the molecular are preferred. Examples of the site having affinity for the hard filler B1 include a carboxy group, a carboxylic anhydride residue, and a carboxylic ester residue. As a site having affinity for the hard filler B1, it is preferable to include a carboxylic anhydride residue from the viewpoint of an upper limit temperature at the time of molding processing. Examples of the carboxylic anhydride residue include maleic anhydride residues and citric anhydride residues, and particularly, maleic anhydride residues are preferred.

The compatibilizer C is preferably a maleic anhydride modified product of the thermoplastic resin A. When the thermoplastic resin A is a polyolefin-based resin, it is preferable that the compatibilizer C is a maleic anhydride modified product of a polyolefin-based resin. When the thermoplastic resin A is a polypropylene-based resin, it is preferable that the compatibilizer C is a maleic anhydride modified product of a polypropylene-based resin. When the thermoplastic resin A is a polyethylene-based resin, it is preferable that the compatibilizer C is a maleic anhydride modified product of a polyethylene-based resin.

As the compatibilizer C, a commercially available product may be used. Examples of the commercially available product of the maleic anhydride modified product of the polyolefin-based resin include MG-441P (product name, manufactured by Riken Vitamin Co., Ltd.) as a maleic anhydride modified product of the polypropylene-based resin, and HE810 (product name, manufactured by Mitsui Chemical Co., Ltd.) as a maleic anhydride modified product of the polyethylene-based resin.

In the thermoplastic resin composition of the present invention, the content of the compatibilizer C is preferably 0.5 to 5% by mass, more preferably 2 to 3% by mass, based on the total mass of the thermoplastic resin A, the hard filler B1, the hard filler B2, and the compatibilizer C, from the viewpoint of selective adsorption to the hard filler B1.

In the thermoplastic resin composition of the present invention, the compatibilizer C is present at least adhering to a surface of the hard filler B1. The compatibilizer C may adhere to the surface of the hard filler B2, if W_{B1}/W_{B2} is 1.5 or more, preferably 3 or more. Here, W_{B1}/W_{B2} is the ratio of the adhesion mass W_{B1} of the compatibilizer C adhered to the surface of the hard filler B1 measured per unit cross-sectional area to the adhesion mass W_{B2} of the compatibilizer C adhered to the surface of the hard filler B2 measured per unit cross-sectional area. It is preferable that the compatibilizer C is not adhered to the surface of the hard filler B2 and is adhered only to the surface of the hard filler B1.

In order to set W_{B1}/W_{B2} within the above ranges, for example, the compatibilizer C is selected to have a higher affinity for the hard filler B1 than for the hard filler B2. Further, for example, in the production of thermoplastic resin compositions, after melt-kneading a mixture of the thermoplastic resin A, the hard filler B1, and the compatibilizer C, melt-kneading is further performed by adding the hard filler B2, whereby W_{B1}/W_{B2} may be made within the above ranges.

### (Other Additives)

In addition to the thermoplastic resin A, the hard filler B, and the compatibilizer C described above, the thermoplastic resin composition of the present invention may contain a known component as an additive within a range not impairing the effect of the present invention. Examples of other additives include flame retardants, anti-drip agents, antioxidants, lubricants, and toughening agents.

### <Flame Retardant>

The flame retardant may be an organic flame retardant or an inorganic flame retardant. Examples of the organic flame retardant include a bromo compound and a phosphorus compound. Examples of the inorganic flame retardant include antimony compounds and metal hydroxides. At least a part of the flame retardant is preferably a phosphorus-based compound. This is because the phosphorus-based compound tends to impart high flame retardancy to the resin composition and has no environmental toxicity.

Phosphorus compounds are typically phosphate ester compounds, and specific examples of phosphate esters include triphenylphosphate, tris(nonylphenyl)phosphate, tris(2,4-di-t-butylphenyl)phosphate, distearylpentaerythritol diphosphate, bis(2,6-di-t-butyl-4-methylphenyl)pentaerythritol diphosphate, bis(2,4-di-t-butylphenyl)pentaerythritol diphosphate, tributylphosphate, bisphenol A bis-diphenylphosphate, and aromatic phosphate, with particular preference being given to aromatic esters. One kind of flame retardant may be used alone, or in combination of 2 or more kinds.

### <Anti-Drip Agent>

The anti-drip agent is added for the purpose of preventing dripping of the resin material during combustion and improving flame retardancy. Examples of the anti-drip agent include a fluorine-based anti-drip agent, a silicon rubber, and a layered silicate. One kind of the anti-drip agent may be used alone, or in combination of 2 or more kinds thereof.

### <Antioxidant>

Examples of the antioxidant include hindered phenols, phosphite ester antioxidants, or a mixed system of both.

### <Lubricant>

Examples of the lubricant include one or 2 or more kinds selected from the group consisting of a fatty acid salt, a fatty acid amide, a silane polymer, a solid paraffin, a liquid paraffin, calcium stearate, zinc stearate, stearic acid amide, a silicone powder, methylene bis stearic acid amide, and a N,N′-ethylene bis stearic acid amide.

### <Toughening Agent>

The toughening agent (or called as impact modifier) is, for example, a resin having rubber elasticity, which is used for the purpose of improving flexibility, processability, and impact resistance of the resin composition. As described above, it is assumed that when an impact modifier is added, the stiffness decreases as a side effect thereof. Therefore, in use, it is noted that the content is adjusted so as not to impair the effect of the present invention.

The toughening agent is preferably a thermoplastic elastomer comprising a soft segment composed of a polymer of a monomer containing butadiene and a hard segment composed of a polymer of a monomer having an aromatic group such as styrene. Examples of the above thermoplastic elastomer include a methylmethacrylate-butadiene-styrene copolymer (MBS), an acrylonitrile-butadiene-styrene copolymer (ABS), a styrene butadiene styrene copolymer (SBS), and a butylacrylate-methylmethacrylate copolymer. Among them, it is preferable that the toughening agent is one or more selected from the group consisting of MBS and ABS from the viewpoint of compatibilizability and flame retardancy of the thermoplastic resin composition and dispersibility of the thermoplastic elastomer in the thermoplastic resin composition. The toughening agent may be used alone, or in combination of one kind or 2 or more kind thereof.

The content of other additives in the thermoplastic resin composition of the present invention is within a range not impairing the effect of the present invention, and it is, for example, in the range of about 0.1 to 30% by mass, and preferably in the range of 0.1 to 20% by mass, based on the total amount of the thermoplastic resin composition. In addition, 30% by mass or less is preferable in total.

[Method for Producing Thermoplastic Resin Composition] The thermoplastic resin compositions of the present invention may be obtained by melt-kneading the thermoplastic resin A, the hard filler B containing the hard filler B1 and the hard filler B2, the compatibilizer C, and other additives which may be optionally contained, so that the above-mentioned W_{B1}/W_{B2} falls within the defined ranges of the present invention.

The thermoplastic resin composition of the present invention is preferably produced by a manufacturing method having, for example, a first step of melt-kneading a thermoplastic resin A, a hard filler B1, and a compatibilizer C to obtain a resin mixture, and then a second step of melt-kneading the resin mixture obtained in the first step and the hard filler B2, from the viewpoint of setting the above W_{B1}/W_{B2} within a defined scope of the present invention.

When the thermoplastic resin composition of the present invention contains other additives, the other additives may be melt-kneaded together with the thermoplastic resin A, the hard filler B1, and the compatibilizer C in the first step, and may be added to the resin mixture obtained in the first step together with the hard filler B2 and melt-kneaded in the second step.

In the manufacturing method of the present invention, the melt-kneading in the first step and the second step is performed using, for example, a kneading apparatus such as a Banbury mixer, a roll mixer, a Plastograph mixer, an extruder (a single screw extruder, a multi-screw extruder (e.g., a twin-screw extruder), and a kneader. Among these, melt-kneading is preferably performed using an extruder because production efficiency is high. Further, since high shear property can be imparted, it is preferable to use a multi-screw extruder for melt-kneading, and more preferable to use a twin-screw extruder. Here, the term extrusion is used in a category including an extruder kneader.

In the manufacturing method of the present invention, a different kneading apparatus may be used for the first step and the second step, but it is preferable to use an extruder in both steps, particularly a twin-screw extruder.

The temperature at the time of melt-kneading (melt-kneading temperature) is equal to or higher than the melting temperature of the thermoplastic resin A in both the first step and the second step. The melt-kneading temperature is preferably 150 to 280° C., for example, when the thermoplastic resin A is a polyolefin-based resin, and is appropriately selected depending on the polyolefin-based resin used. When a polypropylene-based resin is used as the polyolefin-based resin, the melt-kneading temperature is preferably 180 to 270° C., more preferably 180 to 230° C. When it is in the range of the above temperature, the melt-kneading temperature in the first step and the second step may be the same or different. When an extruder is used for melt-kneading, the kneading melting temperature corresponds to the cylinder temperature.

When an extruder is used for melt-kneading, in both the first step and the second step, the screw rotation speed is preferably in the range of 50 to 300 rpm. The number of screw rotation speed in the first step and the second step may be the same or different. In the first step and the second step, the discharge amount of the resin mixture or the thermoplastic resin composition from the extruder is preferably in the range of 1 to 50 kg/hr, respectively.

Before performing the melt-kneading of the first step, each component may be mixed in advance using various mixing machines such as a tumbler or a high-speed mixer known as a Henschel mixer, for example.

In the manufacturing method of the present invention, after the kneaded product is extruded into a strand shape in the second step, the kneaded product extruded into a strand shape may be processed into a form such as a pellet shape or a flake shape.

The thermoplastic resin composition of the present invention may take various forms such as a powdery form, a granular form, a tablet form, a pellet form, a flake form, a fibrous form, and a liquid form.

When the thermoplastic resin composition of the present invention is used, the obtained molded article has rigidity and toughness at a high level.

For example, a molded article molded from a thermoplastic resin composition of the present invention preferably has a flexural modulus measured in a bending test carried out according to JIS-K7171 of 1.2 GPa or more. It is more preferably 1.4 GPa or more, and still more preferably 1.6 GPa or more. When the flexural elastic modulus is 1.2 GPa or more, it may be evaluated that the stiffness of the molded article is practically satisfactory.

For example, in the molded article mold from the thermoplastic resin composition of the present invention, the Charpy impact strength measured in the Charpy impact test performed according to JIS-K7110 is preferably 10 kJ/m² or more, more preferably 13 kJ/m² or more, and still more preferably 15 kJ/m² or more. When the Charpy impact strength is equal to or higher than 10 kJ/m², it can be evaluated that there is no practical problem in the toughness of the molded product.

### (Molded Articles)

Using the thermoplastic resin composition of the present invention, a molded article may be produced. With this molded article, it is possible to obtain a product having both rigidity and toughness at a high level. In producing a molded article, a thermoplastic resin composition may be melted and molded in various molding machines. The molding method may be appropriately selected according to the form and application of the molded article. Examples thereof include injection molding, extrusion molding, compression molding, blow molding, calender molding, and inflation molding. In addition, a sheet-like or film-like molded article obtained by extrusion molding, or calendar molding may be subjected to secondary molding such as vacuum molding or pneumatic molding.

The molded article molded from the thermoplastic resin composition of the present invention is not particularly limited. Examples thereof include electric and electronic components, electric components, exterior components, and interior components in the fields of home appliances and automobiles, and various packaging materials, household products, office products, piping, and agricultural materials.

### EXAMPLES

Hereinafter, the present invention will be specifically described with reference to Examples, but the present invention is not limited thereto. In the examples, “parts” or “%” is used, but unless otherwise specified, it indicates “parts by mass” or “percent by mass”, respectively.

### [Preparation of Thermoplastic Resin Composition]

As raw material components to be contained in the thermoplastic resin composition, the following commercially available products were prepared. Incidentally, the abbreviations described in Table I are shown in parentheses after the generic name of the raw material component.

### <Thermoplastic Resin A>

Polypropylene-based resin (PP): Prime Polypro™ J715M (product name, manufactured by Prime Polymer Co. Ltd.)

Polyethylene resin (PE): HJ560 (product name, manufactured by Japan Polyethylene Corporation)

### <Hard Filler B1>

Aluminum hydroxide particles (Al(OH)₃): KH-101 (product name, manufactured by KC Co. Ltd., average primary particle diameter; 1.0 μm)

Magnesium hydroxide particles (Mg(OH)₂): Magseed™ N-6 (product name, manufactured by Konoshima Chemical Co. Ltd., average primary particle diameter; 1.2 μm, surface-modified with a higher fatty acid)

Mica particles (mica): A-41S (product name, manufactured by Yamaguchi Mica Co. Ltd., average primary particle diameter; 23 μm)

### <Hard Filler B2>

Calcium carbonate particles 1 (Ca carbonate 1): Hakuenka CC-R (product name, manufactured by Shiroishi Kogyo Kaisha Ltd., average primary particle diameter; 0.08 μm, surface modified with a fatty acid)

Calcium carbonate particles 2 (Ca carbonate 2): Hakuenka CC (product name, manufactured by Shiroishi Kogyo Kaisha Ltd., average primary particle diameter; 0.05 μm, surface-modified with a fatty acid)

Silica particles (silica): SO-C2 (product name, manufactured by Admatechs Co. Ltd., average primary particle diameter; 0.5 μm, surface modified with HMDS)

### <Compatibilizer C>

Maleic anhydride-modified polypropylene-based resin (MAH-PP): MG-441P (product name, manufactured by Riken Vitamin Co. Ltd.)

Maleic anhydride-modified polyethylene-based resin (MAH-PE): HE810 (product name, manufactured by Mitsui Chemicals, Inc.)

### (Production of Thermoplastic Resin Composition 1)

Using a twin-screw extrusion kneader “KTX-30” (manufactured by Kobe Steel, Ltd.), 85 parts by mass of polypropylene resin “J715M”, 10 parts by mass of aluminum hydroxide particles “KH-101”, and 2 parts by mass of maleic anhydride-modified polypropylene resin “MG-441P” were melt-kneaded at a cylinder temperature (max.) of 200° C., a die temperature of 190° C., a screw rotation speed of 200 rpm, and a discharge amount of 10 kg/hr to prepare a resin mixture 1 (a first step).

Next, 97 mass parts of the resin mixture 1 and 3 mass parts of calcium carbonate particles “CALSEEDS P” were fused and mixed at a cylinder temperature (max.) 200° C., a die temperature 190° C., a screw rotation speed 200 rpm, and a discharge amount 10 kg/hr (a second step) using the twin-screw extrusion kneader KTX-30 (manufactured by Kobe Steel, Ltd.) (a second step), and the extruded kneaded product was pelleted to obtain a pellet-type thermoplastic resin composition 1.

### (Production of Thermoplastic Resin Compositions 2 to 10)

In the above, the thermoplastic resin compositions 2 to 10 were produced by performing the two times of melt-kneading of the first step and the second step in the same manner as in the thermoplastic resin composition 1, except that the type and the content of the thermoplastic resin A, the hard filler B1, the hard filler B2, and the compatibilizer C were changed as shown in Table I, respectively, then pelletized into pellet-type thermoplastic resin compositions 2 to 10.

### (Production of Thermoplastic Resin Compositions 11 to 13)

In the above, the types and content of thermoplastic resins A, hard fillers B1, hard fillers B2 and compatibles C, respectively, were changed as shown in Table I. Using the twin-screw extrusion kneader “KTX-30” (Kobe Steel, Ltd.), all the raw materials were melted at once under the conditions of a cylinder temperature (maximum) 200° C., a die temperature 190° C., and screw rotation speed of 200 rpm, and pelleted to produce pellet-type thermoplastic resin compositions 11 to 13.

<Measurement of Average Particle Diameter of Hard Filler B1 and Hard Filler B2, and Measurement of W_{B1}/W_{B2}>

### (1) Average Particle Diameter (Average Dispersion Particle Diameter)

Cross sections of the pellets of the thermoplastic resin compositions 1 to 13 obtained above were observed by electron microscopy (JMS-7401F, manufactured by JEOL Ltd.) to obtain images (1000 to 10000 times) for measuring the average particle diameter. Using an image analysis software (Luzex, manufactured by Nireco Co., Ltd.), for 100 dispersed particles of the hard filler B1 and the hard filler B2 randomly extracted from the above image, the circle equivalent diameter was measured, and the average value was determined to be an average particle diameter. The measured results are indicated in Table I.

(2) W_{B1}/W_{B2}

W_{B1}/W_{B2} was calculated for thermoplastic resin compositions 1 to 11 which contained both hard filler B1 and hard filler B2. W_{B1}/W_{B2} is the ratio of the attached mass W_{B1} of the compatibilizer C attached to the surface of the hard filler B1 measured per unit cross-sectional area to the attached mass W_{B2} of the compatibilizer C attached to the surface of the hard filler B2 measured per unit cross-sectional area, and was calculated using the results of nano-IR measurements of the measured areas selected as described above for each of the hard filler B1 and the hard filler B2.

Specifically, the thermoplastic resin composition in the form of pellet (analyte) was made into a flake having a thickness of several hundred nanometers with a microtome, and the flake was observed with an atomic force microscopy (AFM; nanoIR2, manufactured by Analysis Instruments Co.). The hard filler B1 and the hard filler B2 were measured with nano-IR (nanoIR2, manufactured by Analysis Instruments Co.) at 5 locations by determining the measuring areas as described above.

In nano-IR, peak intensities of the maleic acid-derived carbonyl groups (C═O) of compatibilizer C ranging from 1830 to 1890 cm⁻¹ were measured for the measurement area for rigid filler B1 (5 locations) and the measurement area for rigid filler B2 (5 locations), respectively. The value obtained by dividing the average value P_{B1} of the peak intensity measured at 5 locations in the measurement region for the hard filler B1 by the average value P_{B2} of the peak intensity measured at 5 locations in the measurement region for the hard filler B2 was defined as W_{B1}/W_{B2}. The measured results are indicated in Table I.

### <Evaluation>

The thermoplastic resin compositions 1 to 13 obtained above were evaluated for rigidity and toughness by performing the following evaluation. The evaluation results are indicated in Table I.

### (1) Evaluation of Rigidity

After the pellets of each thermoplastic resin composition were dried for 4 hours at 80° C., they were molded into a strip-shaped test piece of 80 mm×10 mm×4 mm by an injection molding apparatus (J55ELII, manufactured by Nippon Steel Works, Ltd.), and flexibly was tested in accordance with JIS-K7171, and the flexural modulus (GPa) was measured and evaluated based on the following criteria. When the flexural modulus is 1.2 GPa or more, it can be evaluated that the rigidity of the molded article is practically satisfactory.

### (Evaluation Criteria)

AA: 1.6 GPa or more

BB: 1.4 GPa or more and less than 1.6 GPa

CC: 1.2 GPa or more and less than 1.4 GPa

DD: less than 1.2 GPa

### (2) Evaluation of Toughness

After the pellets of the thermoplastic resin compositions were dried for 4 hours at 80° C., by using an injection molding apparatus (J1 40AD-110H, manufactured by Nippon Steel Corporation, Ltd.), and they were molded into a strip-shaped test piece of 80 mm×10 mm×4 mm. They were subjected to Charpy impact test in accordance with JIS-K7110. Charpy impact strength (kJ/m²) was measured and evaluated by the following criteria. When the Charpy impact strength is 10 kJ/m² or more, the toughness of the article is considered to be practically satisfactory.

### (Evaluation Criteria)

AA: 15 kJ/m² or higher

BB: 13 kJ/m² or more and less than 15 kJ/m²

CC: 10 kJ/m² or more and less than 13 kJ/m²

DD: less than 10 kJ/m²

The compositions, the dispersion states (average particle diameter) of the hard filler B1 and the hard filler B2, the ratio (W_{B1}/W_{B2}) of the adherence of the compatibilizer C to the hard filler B1 and the hard filler B2, the manufacturing methods, and the physical properties (rigidity and toughness) of the molded articles of the thermoplastic resin compositions 1 to 13 are summarized in Table I. In the manufacturing method, the case where the melt-kneading is divided into the first step and the second step is referred to as “division”. The case where the melt-kneading is performed once is referred to as “one-time”.

TABLE I

| | Thermoplastic resin composition and others | | | | | | | | | | |
|---|---|---|---|---|---|---|---|---|---|---|---|
| | Thermoplastic | | | | | | | | | | |
| Thermoplastic | resin A | | Hard filler B1 | | | Hard filler B2 | | | | Compatibilizer C | |
| resin | | Amount | | | Amount | | | Amount | B1/B2 | | Amount |
| composition | | (parts | | | (parts | | | (parts | mass | | (parts |
| No. | Kind | by mass) | Kind | *1 | by mass) | Kind | *1 | by mass) | ratio | Kind | by mass) |
| 1 | PP | 85 | Al(OH)₃ | 1.0 | 10 | Ca | 0.08 | 3 | 3.3 | MAH-PP | 2 |
| | | | | | | Carbonate 1 | | | | | |
| 2 | PP | 85 | Mg(OH)₂ | 1.2 | 10 | Ca | 0.08 | 3 | 3.3 | MAH-PP | 2 |
| | | | | | | Carbonate 1 | | | | | |
| 3 | PP | 82 | Al(OH)₃ | 1.0 | 12 | Ca | 0.05 | 4 | 3.0 | MAH-PP | 2 |
| | | | | | | Carbonate 2 | | | | | |
| 4 | PP | 80 | Al(OH)₃ | 1.0 | 10 | Ca | 0.08 | 8 | 1.3 | MAH-PP | 2 |
| | | | | | | Carbonate 1 | | | | | |
| 5 | PP | 63 | Al(OH)₃ | 1.0 | 20 | Ca | 0.08 | 12 | 1.7 | MAH-PP | 5 |
| | | | | | | Carbonate 1 | | | | | |
| 6 | PP | 70 | Al(OH)₃ | 1.0 | 25 | Ca | 0.08 | 3 | 8.3 | MAH-PP | 2 |
| | | | | | | Carbonate 1 | | | | | |
| 7 | PP | 78 | Al(OH)₃ | 1.0 | 10 | Silica | 0.5 | 10 | 1.0 | MAH-PP | 2 |
| 8 | PP | 85 | Mica | 33 | 10 | Ca | 0.08 | 3 | 3.3 | MAH-PP | 2 |
| | | | | | | Carbonate 1 | | | | | |
| 9 | PE | 85 | Al(OH)₃ | 1.0 | 10 | Ca | 0.08 | 3 | 3.3 | MAH-PE | 2 |
| | | | | | | Carbonate 1 | | | | | |
| 10 | PP | 85 | Al(OH)₃ | 1.0 | 10 | Ca | 0.08 | 3 | 3.3 | MAH-PE | 2 |
| | | | | | | Carbonate 1 | | | | | |
| 11 | PP | 85 | Al(OH)₃ | 1.0 | 10 | Ca | 0.08 | 3 | 3.3 | MAH-PP | 2 |
| | | | | | | Carbonate 1 | | | | | |
| 12 | PP | 85 | — | — | 10 | Ca | 0.08 | 3 | 3.3 | MAH-PP | 2 |
| | | | | | | Carbonate 1 | | | | | |
| 13 | PP | 85 | Al(OH)₃ | 1.0 | 10 | — | — | 3 | 3.3 | MAH-PP | 2 |

| | State of | | Evaluation | | | | |
|---|---|---|---|---|---|---|---|
| Thermoplastic | Compatibilizer | Production | Charpy impact | | Flexural | | |
| resin | nano-IR | method | strength | | modulus | | |
| composition | analysis | Melt-kneading | Value | | Value | | |
| No. | W_{B1}/W_{B2} | method | (kJ/m²) | Evaluation | (GPa) | Evaluation | Remarks |
| 1 | 12.4 | Division | 13 | BB | 1.4 | BB | Present |
| | | | | | | | Invention |
| 2 | 10.2 | Division | 14 | BB | 1.5 | BB | Present |
| | | | | | | | Invention |
| 3 | 16.7 | Division | 20 | AA | 1.4 | BB | Present |
| | | | | | | | Invention |
| 4 | 18.0 | Division | 11 | CC | 1.5 | BB | Present |
| | | | | | | | Invention |
| 5 | 3.3 | Division | 11 | CC | 1.6 | AA | Present |
| | | | | | | | Invention |
| 6 | 11.9 | Division | 10 | CC | 1.7 | AA | Present |
| | | | | | | | Invention |
| 7 | 8.4 | Division | 12 | CC | 1.5 | BB | Present |
| | | | | | | | Invention |
| 8 | 4.2 | Division | 10 | CC | 2.4 | AA | Present |
| | | | | | | | Invention |
| 9 | 13.7 | Division | 13 | BB | 1.2 | CC | Present |
| | | | | | | | Invention |
| 10 | 11.1 | Division | 10 | CC | 1.4 | BB | Present |
| | | | | | | | Invention |
| 11 | 1.2 | One-time | 6 | DD | 1.4 | BB | Comparative |
| | | | | | | | Example |
| 12 | — | One-time | 10 | CC | 1.1 | DD | Comparative |
| | | | | | | | Example |
| 13 | — | One-time | 8 | DD | 1.4 | BB | Comparative |
| | | | | | | | Example |

*1: Average particle diameter (μm)

From Table I, it can be seen that the molded article obtained from the thermoplastic resin composition of the present invention has both rigidity and toughness at a high level.

Although embodiments of the present invention have been described and illustrated in detail, the disclosed embodiments are made for purposes of illustration and example only and not limitation. The scope of the present invention should be interpreted by terms of the appended claims.

What is claimed is:

1. A thermoplastic resin composition containing a thermoplastic resin A, a hard filler B and a compatibilizer C, wherein the hard filler B contains a hard filler B1 having an average particle diameter in the range of 0.7 to 40 μm and a hard filler B2 having an average particle diameter in the range of 0.01 to 0.5 μm, the compatibilizer C at least adheres to a surface of the hard filler B1, and a ratio W_{B1}/W_{B2} is 1.5 or more, when W_{B1} and W_{B2} are adhesion masses of the compatibilizer C adhered to the surfaces of the hard filler B1 and the hard filler B2, respectively, and W_{B1} and W_{B2} each are measured per unit cross-sectional area.

2. The thermoplastic resin composition described in claim 1, wherein the ratio W_{B1}/W_{B2} of the adhesion masses is 3 or more.

3. The thermoplastic resin composition described in claim 1, wherein a ratio B1/B2 of a mass of the hard filler B1 to a mass of the hard filler B2 is in the range of 2.0 to 5.0.

4. The thermoplastic resin composition described in claim 1, wherein a content of each of the thermoplastic resin A, the hard filler B1, the hard filler B2, and the compatibilizer C based on the total mass of the thermoplastic resin composition is 65 to 90% by mass for the thermoplastic resin A, 5 to 20% by mass for the hard filler B1, 1 to 10% by mass for the hard filler B2, and 0.5 to 5% by mass for the compatibilizer C.

5. The thermoplastic resin composition described in claim 1, wherein that the average particle diameter of the hard filler B1 is in the range of 0.8 to 5 μm and the average particle diameter of the hard filler B2 is in the range of 0.03 to 0.2 μm.

6. The thermoplastic resin composition described in claim 1, wherein the thermoplastic resin A is a polypropylene resin.

7. The thermoplastic resin composition described in claim 1, wherein a constituent material of the hard filler B1 is any of magnesium hydroxide, aluminum hydroxide, boehmite, talc, or mica.

8. The thermoplastic resin composition described in claim 1, wherein a constituent material of the hard filler B2 is any of calcium carbonate, silica, kaolin, aluminum hydroxide, or boehmite.

9. The thermoplastic resin composition described in claim 1, wherein the compatibilizer C is a maleic anhydride modified form of the thermoplastic resin A.

10. A method for producing the thermoplastic resin composition described in claim 1, comprising the steps of:
melt-kneading the thermoplastic resin A, the hard filler B1, and the compatibilizer C to obtain a resin mixture (a first step); and
melt-kneading the resin mixture and the hard filler B2 (a second step).
